(19) United States
(12) Patent Application Publication
(10) Pub. No.: US 2014/0262712 A1
(43) Pub. Date: Sep. 18, 2014

(54) WATER-PROOF BUTTON ASSEMBLY AND OBJECT WITH THE WATER-PROOF BUTTON ASSEMBLY

(71) Applicant: Te-Yi CHU, New Taipei City (TW)

(72) Inventor: Te-Yi CHU, New Taipei City (TW)

(21) Appl. No.: 13/795,729

(22) Filed: Mar. 12, 2013

(51) Int. Cl. H01H 13/06

(52) U.S. Cl. CPC H01H 13/06
USPC 200/302.2

(57) ABSTRACT

A water-proof button assembly includes a seat, a sealing member, a button and a contact member. The seat has an opening and an inward protrusion extends inward from the inside of the opening. The sealing member is installed in the opening and has a through hole which is defined by an outer portion. The outer portion contacts the inward protrusion of the seat. The diameter of the outer portion is larger than the diameter of the button. The contact member is located corresponding to the button and contacts the inward protrusion. When the button is pressed, the force pushes the sealing member to contact against the inside of the opening of the seat to enhance the sealing effect between the sealing member and the opening. The sealing member provides a bouncing force for returning the button to the initial position.

### FIELD OF THE INVENTION

The present invention relates to a water-proof button assembly and an object with the water-proof button assembly, and more particularly, to a water-proof button assembly with a sealing member which seals the opening when the button is not pressed and contacts the inside of the opening of the seat when the button is pushed.

### BACKGROUND OF THE INVENTION

There are various buttons are installed to different types of devices such as the volume buttons, switch buttons and keypads of electronic devices. In order to prevent water and dust from entering the interior of the device, these buttons are designed to be water-proof. One of the conventional water-proof buttons is disclosed in Taiwan Patent Publication No. 499035, titled “Button structure with dustproof and waterproof function”, which comprises a button connected to a circuit board. and the button has a mediate board, a resilient member and a keypad. The mediate board has a seat and a stepped portion is formed on the top of the seat. The resilient member is mounted to the stepped portion, and the keypad is connected to the resilient member. The keypad has an insertion which is inserted into the seat, and the insertion is in contact with the circuit when the keypad is pressed. The insertion is engaged with the seat when the keypad is released.

However, the resilient member has one end mounted to the stepped portion on the mediate board, and the resilient member tends to shift laterally and disengage from the stepped portion when the keypad is pressed, so that the keypad is difficult to maintain its enclosed feature for dust-proof or water-proof.

Further, the stepped portion on the mediate board, the resilient member and the keypad are exposed beyond the mediate board so that the volume of the button assembly is bulky.

The present invention intends to provide a water-proof button assembly which is compact and prevents water and dust from entering the button assembly.

### SUMMARY OF THE INVENTION

The present invention relates to a water-proof button assembly and comprises a seat having an opening and an inward protrusion extends inwardly from the inside of the opening. The inward protrusion has a protruding depth “t”. A sealing member is installed in the opening and has a original depth T1. The sealing member has a through hole which is located corresponding to the opening. The through hole is defined by an outer portion which contacts the inward protrusion of the seat. The diameter of the outer portion is S1. A button contacts the sealing member and has a first connection portion which is located corresponding to the through hole. A first contact face of the button is contacted to the top of the sealing member so as to form a sealed status. The diameter of the button is S2 which is smaller than the diameter S1 of the outer portion. A contact member is located corresponding to the button and contacts the inward protrusion. The contact member has a second connection portion which is connected to the first connection portion. A second contact face of the contact member is contacted to the bottom of the inward protrusion so as to form a sealed status. A distance “d” is defined between the first contact face of the button and the second contact face of 0the contact member. The sum of the protruding and original depths “t”, T1 is larger than the distance “d”, such that the sealing member is snugly clamped between the button and the contact member. The sealing member contacts the inward protrusion in the opening.

Preferably, the first connection portion of the button is a rod/protruding portion and the second connection portion of the contact member is a recess with which the first connection portion is engaged.

Preferably, the first connection portion of the button is a recess and the second connection portion of the contact member is a rod/protruding portion which is engaged with the first connection portion.

The present invention also provides an object with a water-proof button assembly, and comprises a housing having a room defined therein. The housing has at least one seat which has an opening communicating with the room. A inward protrusion extends inwardly from the inside of the opening and has a protruding depth “t”. A sealing member is installed in the opening and has a original depth T1. The sealing member has a through hole which is located corresponding to the opening. The through hole is defined by an outer portion and the outer portion contacts the inward protrusion of the at least one seat. The diameter of the outer portion is S1.

A button contacts the sealing member and has a first connection portion which is located corresponding to the through hole. A first contact face of the button is contacted to the top of the sealing member so as to form a sealed status. The diameter of the button is S2 which is smaller than the diameter S1 of the outer portion. A contact member is located corresponding to the button and contacts the inward protrusion. The contact member has a second connection portion which is connected to the first connection portion. A second contact face of the contact member is contacted to the bottom of the inward protrusion so as to form a sealed status. A distance “d” is defined between the first contact face of the button and the second contact face of the contact member. The sum of the protruding and original depths is larger than the distance “d”, such that the sealing member is snugly clamped between the button and the contact member. The sealing member contacts the inward protrusion in the opening.

Preferably, the first connection portion of the button is a rod/protruding portion and the second connection portion of the contact member is a recess with which the first connection portion is engaged.

Preferably, the first connection portion of the button has multiple notches defined in the outside thereof, and the second connection portion of the contact member has multiple ribs defined on the inside thereof, the ribs are engaged with the notches.

One aspect of the present invention is to provide a water-proof button assembly wherein when the button is not pressed, the sealing feature/effect is available. When the button is pressed, the force pushes and expands the outer portion of the sealing member to contact against the inside of the opening of the seat to enhance the sealing effect between the sealing member and the opening. The sealing member provides a bouncing force for returning the button to the initial position.

Another aspect of the present invention is to provide a water-proof button assembly wherein the sealing member and the button are configured to be installed and accommodated in the opening of the seat, such that the overall volume of the water-proof button assembly is reduced. The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the first embodiment of the water-proof button assembly of the present invention;

FIG. 2 is an exploded view to show the cross sectional views of the first embodiment of the water-proof button assembly of the present invention;

FIG. 3 is a perspective view to show the first embodiment of the water-proof button assembly of the present invention;

FIG. 4 is a cross sectional view to show the first embodiment of the water-proof button assembly of the present invention;

FIG. 5 is a cross sectional view to show that the button of the first embodiment of the water-proof button assembly of the present invention is pressed;

FIG. 6 is a cross sectional view to show another example of the first embodiment of the water-proof button assembly of the present invention;

FIG. 7 is a perspective view to show the second embodiment of the water-proof button assembly of the present invention;

FIG. 8 is a cross sectional view to show the second embodiment of the water-proof button assembly of the present invention;

FIG. 9 is a cross sectional view to show the embodiment disclosed in FIG. 7.

### DETAILED DESCRIPTION OF THE PREFERRED EMBODIMENT

Referring to FIGS. 1 to 4, the first embodiment of the water-proof button assembly of the present invention comprises a seat 1 having an opening 11 and an inward protrusion 12 extends inwardly from the inside of the opening 11. The inward protrusion 12 has a protruding depth “t”.

A sealing member 2 is installed in the opening 11 and has an original depth T1 without being compressed. The sealing member 2 has a through hole 21 which is located corresponding to the opening 11. The through hole 21 is defined by an outer portion 22, and the outer portion 22 contacts the inward protrusion 12 of the seat 1. The outer diameter of the outer portion 22 is S1 which is located corresponding to the opening 11, so that the outer portion 22 contacts the inside of the opening 11 to form a sealed status.

A button 3 has a first connection portion 31 and a first contact face 32. The first connection portion 31 is located corresponding to the through hole 21. The first contact face 32 is contacted to the top of the sealing member 2 so as to form a sealed status. The outer diameter of the button 3 is S2 which is smaller than the outer diameter S1 of the outer portion 22. A contact member 4 is located corresponding to the button 3.

The contact member 4 has a second connection portion 41 and a second contact face 42. The second connection portion 41 is connected to the first connection portion 31. When the button 3 is not pressed downwardly (as shown in FIG. 4), the second contact face 42 is contacted to the bottom of the inward protrusion 12 so as to form a sealed status. Preferably, when assembled, the first connection portion 31 is configured to be installed through the hole 21 and engaged to the second connect portion 41. A distance “d” is defined between the first contact face 32 of the button 3 and the second contact face 42 of the contact member 4.

It is noted that the first connection portion 31 of the button 3 is a protruding portion and the second connection portion 41 of the contact member 4 is a recess with which the first connection portion 31 is engaged (as shown in FIG. 4). Alternatively, the first connection portion 31 of the button 3 can be a recess, and the second connection portion 41 of the contact member 4 can be a protruding portion which is engaged with the first connection portion 31 (as shown in FIG. 6).

As shown in FIGS. 1 and 4, the sealing member 2 is installed in the opening 11 of the seat 1, and the outer portion 22 of the sealing member 2 contacts the inward protrusion 12 of the seat 1. The first connection portion 31 of the button 3 extends through the through hole 21 of the sealing member 2 and the opening 11 of the seat 1. The second contact face 42 is arranged to contact to the bottom of the inner protrusion 12, and the first connection portion 31 of the button 3 is then engaged with the second connection portion 41 of the contact member 4. The sum of the protruding and original depths “t”, T1 is larger than the distance “d”, so that the sealing member 2 is snugly clamped between the button 3 and the contact member 4 and has a clamped depth T2. The sealing member 2 contacts the inward protrusion 12 in the opening 11 to form a sealed status. Wherein, the sealing member 2 and button 3 are configured to be installed and accommodated in the opening 11 of the seat 1, such that the overall volume of the water-proof button assembly is reduced.

As shown in FIGS. 2 and 5, when in use, the water-proof button assembly is installed to an object B, and the opening 11 of the seat 1 communicates with an inner space of the object B and is located corresponding to a target part A, such as the switch button, the volume adjustment button or the keypad, of the object B.

When the user presses the button 3 downward, the sealing member 2 is squeezed and the contact member 4 is lowered and separated from the inward protrusion 12 of the seat 1 so as to contact the target part A. When the button 3 is pressed, because the outer diameter S1 of the outer portion 22 is larger than the outer diameter S2 of the button 3, the pressed force transmitted from the button 3 to the sealing member 2 generates the corresponding bending force and deformation to the outer portion 22. Consequently, the outer portion 22 is expanded outward and contacts against the inside of the opening 11, and the clamped depth T2 of the sealing member is further compressed to a compressed depth T3 (As shown in FIG. 5). Therefore, the pressing force applied to the button 3 further enhances the sealing effect of the sealing member 2. When the button 3 is released, the sealing member 2 quickly bounces back, so that the button 3 returns to its initial position.

As shown in FIGS. 7 to 9, the second embodiment of the present invention provides an object with a water-proof button assembly, and comprises a housing 10 of an electric device, a cellular phone for example, and the housing has a room 101 defined therein. The opening 11 of the seat 1 is located in the housing 10 and communicates with the room 101. Preferably, the seat 1 is made as an integral part with the housing 10 or is attached/installed to the housing 10, such that the seat 1 can be seen as a part of the housing 10. The protruding portion/first connection portion 31 of the button 3 has multiple notches 311 defined in the outside thereof, and the recess/second connection portion 41 of the contact member 4 has multiple ribs 411 defined on the inside thereof. The ribs 411 are engaged with the notches 311 so as to enhance the connection between the button 3 and the contact member 4.

While we have shown and described the embodiment in accordance with the present invention, it should be clear to those skilled in the art that further embodiments may be made without departing from the scope of the present invention.

What is claimed is:

1. A water-proof button assembly comprising:
a seat having an opening and a inward protrusion extending inward from an inside of the opening, the inward protrusion having a protruding depth;
a sealing member installed in the opening and having an original depth, the sealing member having a through hole which is located corresponding to the opening, the through hole being defined by an outer portion, the outer portion contacting the inward protrusion of the seat, an outer diameter of the outer portion being S1;
a button having a first connection portion and a first contact face, the first connection portion is located corresponding to the through hole, the first contact face contacted to the top of the sealing member, an outer diameter of the button being S2 which is smaller than the outer diameter S1 of the outer portion, and
a contact member located corresponding to the button, the contact member having a second connection portion and a second contact face, the second connection portion is connected to the first connection portion, the second contact face contacting to the bottom of the inward protrusion, a distance defined between first contact face of the button and the second contact face of the contact member, a sum of the protruding and original depths being larger than the distance, the sealing member being snugly clamped between the button and the contact member, the sealing member contacting the inward protrusion in the opening.

2. The assembly as claimed in claim 1, wherein the first connection portion of the button is a protruding portion and the second connection portion of the contact member is a recess with which the protruding portion is engaged.

3. The assembly as claimed in claim 1, wherein the first connection portion of the button is a recess and the second connection portion of the contact member is a protruding portion which is engaged with the recess.

4. An object with a water-proof button assembly, comprising:
a housing having a room defined therein, the housing having at least one seat, the at least one seat having an opening which communicates with the room, an inward protrusion extending inward from an inside of the opening and having a protruding depth;
a sealing member installed in the opening and having an original depth, the sealing member having a through hole which is located corresponding to the opening, the through hole being defined by an outer portion, the outer portion contacting the inward protrusion of the at least one seat, an outer diameter of the outer portion being S1;
a button having a first connection portion and a first contact face, the first connection portion is located corresponding to the through hole, the first contact face contacted to the top of the sealing member, an outer diameter of the button being S2 which is smaller than the outer diameter S1 of the outer portion, and
a contact member located corresponding to the button, the contact member having a second connection portion and a second contact face, the second connection portion is connected to the first connection portion, the second contact face contacting to the bottom of the inward protrusion, a distance defined between the first contact face of the button and the second contact face of the contact member, a sum of the protruding and original depths being larger than the distance, the sealing member being snugly clamped between the button and the contact member, the sealing member contacting the inward protrusion in the opening.

5. The object as claimed in claim 4, wherein the first connection portion of the button is a protruding portion and the second connection portion of the contact member is a recess with which the protruding portion is engaged.

6. The object as claimed in claim 5, wherein the first connection portion of the button has multiple notches defined in an outside thereof, and the second connection portion of the contact member has multiple ribs on an inside thereof, the ribs are engaged with the notches.
